(19) United States
(12) Patent Application Publication
(10) Pub. No.: US 2008/0157547 A1
(43) Pub. Date: Jul. 3, 2008

(54) Motor Vehicle With an Underprotection Device

(75) Inventors: Karl-Heinz Baumann, Bondorf (DE); Frank Engels, Drolshagen (DE); Michael Fehring, Neuhausen (DE); Asa Haerdner, Stuttgart (DE); Eckhard Hauer, Gummersbach (DE); Rainer Justen, Altdorf (DE); Bengt Larsson, Sindelfingen (DE); Reinhard Nowack, Drolshagen (DE); Bernd Orschiedt, Gerlingen (DE); Gerhard Reuber, Drolshagen (DE); Stephan Roehner, Dortmund (DE); Thomas Zink, Ehningen (DE)

Correspondence Address: CROWELL & MORING LLP;INTELLECTUAL PROPERTY GROUP, P.O. BOX 14300, WASHINGTON, DC, 20044-4300, US

(73) Assignee: Daimler AG, Stuttgart (DE)

(21) Appl. No.: 11/965,869

(22) Filed: Dec. 28, 2007

Related U.S. Application Data
(63) Continuation of application No. PCT/EP2006/006288, filed on Jun. 29, 2006.

(30) Foreign Application Priority Data
Jun. 30, 2005 (DE) 10 2005 030 419.2

(51) Int. Cl. B60R 19/38

(52) U.S. Cl. 293/118

(57) ABSTRACT

An off-road vehicle, a pickup, or other such vehicle has an underprotection device with an impact plate fitted to the underside of the motor vehicle. To provide an improved underprotection device, the impact plate is fitted to the underside in a manner such that it is movable between retracted and extended positions.

This application is a continuation of international PCT application PCT/EP2006/006288, filed Jun. 29, 2006, the entire disclosure of which is incorporated herein by reference.

This application also claims the priority of German application 10 2005 030 419.2, filed Jun. 30, 2005.

### BACKGROUND AND SUMMARY OF THE INVENTION

The present invention relates to a motor vehicle, in particular to an off-road vehicle or a pickup, with an underprotection device having an impact plate that is fitted to the underside of the motor vehicle.

In a motor vehicle with a large ground clearance and a high overhang angle, there is the risk of a lower front structure of conventional passenger vehicles being overridden in the event of a collision. This leads to the passenger vehicle with the lower front structure driving under the motor vehicle with the larger ground clearance. In order to avoid such underriding, it is known to provide off-road vehicles or pickups with underprotection devices.

German document DE 103 37 620 A1 discloses a motor vehicle with a Pre-Safe System including at least one vehicle environment detection device and a spring and shock absorber device arranged between a chassis and a vehicle body. The spring and shock absorber device can be activated as a function of the signals captured by the vehicle environment detection device and evaluated in a data evaluation device. The data evaluation device of the vehicle environment detection device is linked to a control unit of an active chassis control system, which activates the spring and shock absorber device and by means of which a vehicle level adjustment, which is predefined for the particular impact situation and is at least substantially a lifting motion, is carried out.

German document DE 42 16 025 A1 discloses a protection device for a rail vehicle with an impact body fitted to its front end. In order to prevent a person being run over, and in order to minimize serious impact-related injuries to that person, the impact body covers the entire width of the vehicle, reaches to about 2 m above the upper edge of the rail, and is composed of plastic material of considerable thickness. A lower part of the impact body can be mounted on its rear line to the remaining, fixed part of the impact body by means of a rotary joint. The intercepting body can be acted upon from above by at least one actuating element, which is triggered by an emergency switch and/or by the automatic braking system and/or by a braking system actuated by the driver.

British document GB 2384215 A reveals a motor vehicle of the type in question with an underprotection device which comprises an impact plate. The impact plate is fitted to the underside of the motor vehicle in a manner such that it is movable between a retracted and an extended position.

It is an object of the invention to provide a motor vehicle, in particular an off-road vehicle or a pickup, having an improved underprotection device.

To achieve the object, a motor vehicle having an underprotection device with an impact plate fitted to the underside of the motor vehicle and movable between a retracted and an extended position is proposed. The impact plate can be arranged at the front, the rear, or laterally on the underside of the motor vehicle. A plurality of impact plates may also be arranged at different locations. In its retracted position, the impact plate permits a large ground clearance and a high overhang angle. In its extended position, the impact plate prevents the underriding of a collision partner with a low front structure by using an impact surface or impact edge arranged at a lower level, preferably level with its crash structure, to provide resistance to the collision vehicle. In its extended position, the underprotection device therefore takes on the function of an underride protection device.

Owing to the regions of differing rigidity, an impact plate can be realized with a deformation characteristic suitable for avoiding damage to an integral member of the vehicle supporting structure, which integral member is located behind the underprotection, upon collisions at lower speeds.

In a preferred exemplary embodiment of the motor vehicle, the impact plate is fitted pivotably to the underside of the motor vehicle. The impact plate is preferably mounted pivotably by way of one or more pivot bearings preferably arranged in the region of the front axle of the motor vehicle. The pivotable fitting can also take place by way of a line of weakness in the manner of a film hinge. In an advantageous exemplary embodiment, the impact plate is coupled to a stabilizer, which, in turn, can be fitted to an integral member.

In a further preferred exemplary embodiment of the motor vehicle, the impact plate is coupled to a front axle member of the motor vehicle. Large longitudinal forces directed in the longitudinal direction of the vehicle can be introduced by the impact plate into the supporting structure of the motor vehicle via the front axle member.

In a further preferred exemplary embodiment of the motor vehicle, the impact plate extends into a bumper region, in particular a front bumper region, of the motor vehicle. In the extended position of the impact plate, the outer, front end of the impact plate is preferably arranged between the front or rear bumper region of the motor vehicle and the ground. As a result, the ground clearance of the motor vehicle can be reduced in this region.

In a still further preferred exemplary embodiment of the motor vehicle, an actuator device is provided for displacing the impact plate. The actuator device here acts on the impact plate, for example in the region thereof which is adjacent to the front bumper region of the motor vehicle. According to a first variant, the actuator device serves to pivot the impact plate from its retracted position into its extended position, and vice-versa. According to a second variant, the actuator device serves exclusively to reset the extended impact plate into its retracted basic position. In this variant, the displacement of the impact plate from its retracted position into its extended position can take place, for example, automatically on account of the intrinsic weight of the impact plate and, if appropriate, additionally supported by way of spring force.

The actuator device can be arranged in front of, on or behind a crash box. The actuator device is preferably fitted behind the crash box in order to prevent damage to the actuator device during relatively minor accidents.

In a further preferred exemplary embodiment of the motor vehicle, the actuator device is fitted behind a front bumper region to the supporting structure of the motor vehicle. The actuator device is preferably fitted to a crossmember of the supporting structure or to a bumper bending member of the motor vehicle. The actuator device is preferably arranged behind a crash box in order to avoid damage to the actuator device at low impact speeds.

In a further preferred exemplary embodiment of the motor vehicle, the actuator device comprises a plurality of actuator elements which can form a supporting base for an impacting collision partner when the impact plate is in its extended position. In the extended position of the impact plate, the actuator elements preferably extend in the vertical direction, i.e. essentially perpendicularly to the ground.

In a further preferred exemplary embodiment of the motor vehicle, the impact plate is deformable in a defined manner in the longitudinal direction of the motor vehicle. The effect achieved by an intended, defined deformation of the impact plate is that, upon a collision with a collision partner, impact forces can be absorbed.

In a further preferred exemplary embodiment of the motor vehicle, the impact plate has high intrinsic rigidity in the longitudinal direction of the motor vehicle. The intrinsic rigidity of the impact plate, which is essentially of sheetlike, i.e. plate-like, design, is preferably achieved by the thickness of its wall or by corresponding embossings on the impact plate, preferably in the longitudinal direction of the motor vehicle. The embossed impact plate can also be configured, by means of a closing plate, to be in the form of two shells, thus producing support elements. The impact plate can also open on its front side into a support part, which provides a load-distributing effect when a pivotable structural module is activated.

In a further preferred exemplary embodiment of the invention, the impact plate comprises an outer, front region of rigidity, in which folding aids are provided, and an inner, rear region of rigidity which has significantly higher intrinsic rigidity in the longitudinal direction of the motor vehicle than the outer, front region of rigidity. In the event of a crash, the front region is preferably activated together with a bending crossmember and crash boxes, i.e. is subjected to force by the collision partner. The rear region preferably has significantly higher intrinsic rigidity in the longitudinal direction. During collisions at high speeds, energy/forces can therefore be introduced into integral members of the vehicle supporting structure by the additional load path. The force level of the impact plate, in particular in the form of two shells, can be matched in a specific manner to the particular requirements via a corresponding bead geometry or by different wall thicknesses of the shells, for example by flexibly rolled raw materials. By means of specific embossing of the shells, a better overlapping with the accident counterpart can be achieved. The impact plate can be of deformable design at the front and/or at the rear in multistages or continuously. The rigidity preferably increases continuously from the front to the rear.

According to a further preferred exemplary embodiment of the motor vehicle, the outer, front deformation section is of interchangeable design. This simplifies the repair of the underprotection device. In addition, costs are saved, since, after an accident at low speeds, only a part of the impact plate has to be interchanged rather than the entire impact plate.

In a further preferred exemplary embodiment of the motor vehicle, the impact plate comprises an outer, front deformation section, which is fitted to an inner, rear supporting section that has higher rigidity than the outer deformation section. The aim of the different levels of rigidity is to realize, for collisions at lower speeds, a deformation characteristic which avoids damaging an integral member of the vehicle supporting structure, which integral member is located behind the underprotection. The front region in front of the region in which the actuator assembly is connected can therefore be configured such that it is of interchangeable design.

In a further preferred exemplary embodiment of the motor vehicle, the deformation section is fitted pivotably to the supporting section. The pivotability can be realized, for example, by means of a defined bending edge or a line of weakness or by one or more pivot bearings.

In a further preferred exemplary embodiment of the motor vehicle, the impact plate is movable from the retracted into the extended position by motor or manually. Motorized lowering of the impact plate results in an inlet opening in the front end structure of the motor vehicle, which inlet opening can also be used in another manner and provides a series of further possibilities, for example for accommodating tools.

In a further preferred exemplary embodiment of the motor vehicle, the impact plate is arranged in its extended position during normal operation of the motor vehicle and is moved into the retracted position only when the need arises. The impact plate can be displaced, in particular pivoted, upward in the off-road mode, for example via a manual control system.

In a still further preferred exemplary embodiment of the motor vehicle, the impact plate is arranged in its retracted position during normal operation of the motor vehicle and is moved into the extended position only when the need arises. The movement of the impact plate is preferably controlled via a corresponding Pre-Crash activation or Pre-Safe activation. The lowering and a locking in the extended position, which is also referred to as the compatibility position, are only initiated in the Pre-Safe situation or in the Pre-Crash situation.

Further advantages, features and details of the invention emerge from the description below in which various exemplary embodiments are described in detail with reference to the drawing. The features emerging from the claims and the description may each be essential to the invention individually in themselves or in any desired combination.

### BRIEF DESCRIPTION OF THE DRAWING

FIG. 1 shows the front region of a motor vehicle with an underprotection device in section, and with an impact plate of the underprotection device in its retracted position;

FIG. 2 shows the front region of the motor vehicle according to FIG. 1, and with the impact plate in its extended position;

FIG. 3 shows the front region of a motor vehicle with an underprotection device in section according to a second exemplary embodiment, and with an impact plate in its retracted position;

FIG. 4 shows a detail from FIG. 3, but with the impact plate in its extended position;

FIG. 5 shows the motor vehicle partially illustrated in FIGS. 3 and 4 at the moment of collision with a barrier;

FIG. 6 shows the front region of a motor vehicle with an underprotection device according to a third exemplary embodiment;

FIG. 7 shows the underprotection device from FIG. 6 upon a collision at a relatively low speed;

FIG. 8 shows an underprotection device similar to the one in FIG. 7 but in accordance with a fourth exemplary embodiment; and

FIG. 9 is a perspective illustration of a fifth exemplary embodiment of the underprotection device according to the invention.

### DETAILED DESCRIPTION OF THE INVENTION

FIG. 1 illustrates the front region of a supporting structure 1 of a motor vehicle schematically in section. An underprotection device 2 is fitted to the supporting structure 1. The supporting structure 1 comprises a front end 4 of a longitudinal member 5. A connecting member 7 extends from the front end 4 of the longitudinal member 5 in the longitudinal direction of the motor vehicle. A crossmember 9 is fitted to the front end of the connecting member 7. The crossmember 9 serves for the fastening of a front bumper 10.

Furthermore, a connecting member 12 extends vertically downward from the upper longitudinal member 5 of the vehicle supporting structure 1. A further, lower longitudinal member 14 stabilizes the connecting member 12 at its lower end. An impact plate 16, which has a rear end 17 and a front end 18, is fitted pivotably to the lower end of the connecting member 12. At its rear end 17, the impact plate 16 is fitted to the lower end of the connecting member 12 in a manner such that it can pivot about an axis 20 running transversely with respect to the longitudinal direction of the vehicle and perpendicular to the plane of the image in FIG. 1. The axis 20 constitutes a coupling point of the impact plate 16 to the supporting structure 1.

At its front end 18, the impact plate 16 has a further coupling point 22, with the aid of which the impact plate 16 is coupled to one end of an actuator device 24 (merely indicated by a double arrow). The other end of the actuator device 24 is coupled to the crossmember 9 of the supporting structure 1 via a coupling point 25.

FIG. 1 illustrates the impact plate 1 in its retracted position. In the retracted position, the impact plate 16 permits a high overhang angle and large ground clearance. There is virtually no gap between the front end 18 of the impact plate 16 and the bumper 10, in which objects may become caught or penetrate.

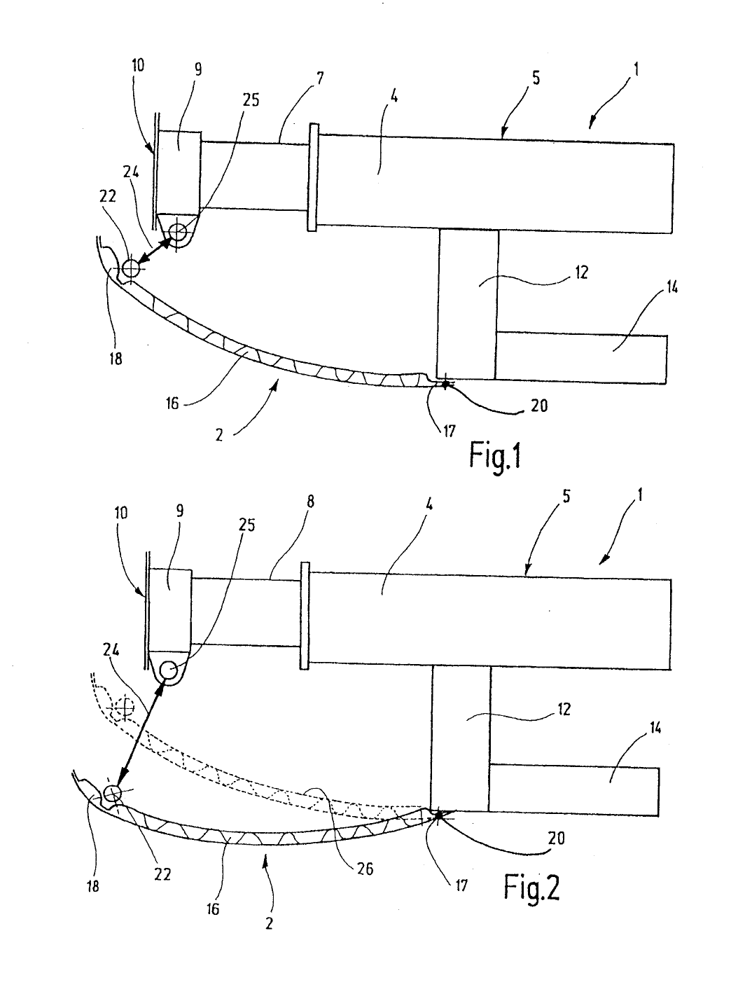

FIG. 2 illustrates the impact plate 16 in its extended position by means of a solid line, and in its retracted position by means of a dashed line 26. In its extended position, the impact plate 16 also provides a supporting structure for lower collision partners, such as, for example, conventional passenger vehicles, on which supporting structure the lower vehicle can activate its front end structure. This reliably avoids an off-road vehicle equipped with the underprotection device 2 according to the invention “overriding” lower vehicles.

The underprotection device 2 according to the invention is preferably fitted under the front axle member and raised as far as the bumper region. The impact plate 16 is connected at its rear end 17 to the front axle member or to another load-bearing element of the supporting structure 1, which is also referred to as the body shell, in the manner of a hinge and can introduce great longitudinal forces there into the supporting structure of the vehicle body. At its front end 18, the impact plate 16 is connected to the front crossmember 9 or to the bumper bending member via the actuator device 24. The actuator device 24 may comprise actuator elements, which can be pivoted, retracted, and/or extended or operated in the manner of a toggle lever. The impact plate 16 can be pivoted about its rear, hinge-like fastening 20 via the actuator elements. The actuator elements are preferably designed in such a manner that they form a supporting base for an impacting vehicle or other collision partners to the front toward the front side of the vehicle.

The pivoting movement can be triggered either manually or via a Pre-Safe activation or Pre-Crash activation. Upon manual activation, the normal position of the underprotection device 2 is in the lowered or extended position of the impact plate 16. The impact plate 16 is pivoted upward only in the off-road mode. Upon Pre-Safe activation or Pre-Crash activation, the impact plate 16 is in its retracted position during normal operation. Lowering and locking of the impact plate 16 in its extended position, which is also referred to as the compatibility position, are initiated only in the Pre-Safe situation or Pre-Crash situation. The pivoting movement of the impact plate 16 preferably takes place reversibly. In the event of no impact taking place after activation of the impact plate 16, the impact plate can be reset into its starting position. The resetting movement can be carried out manually or automatically, preferably by means of the actuator device 24.

The impact plate 16 has such intrinsic rigidity that, during a collision, it forms an impact absorber and therefore a compatible structure for smaller vehicles of rather low construction. By means of the impact plate 16 arranged and designed according to the invention, the inclination of the underside of the motor vehicle with respect to the horizontal is reduced. As a result, the tendency of the motor vehicle to override the collision partner is reduced. In addition, the design according to the invention of the impact plate 16 results in the creation of a deformation element in the longitudinal direction. The intrinsic rigidity of the impact plate 16 is achieved by a corresponding thickness of its wall or by corresponding embossings of the sheetlike impact plate 16, which preferably run in the longitudinal direction of the motor vehicle. The principle of the pivotable impact plate is basically also suitable for rear structures in order to avoid underriding of the rear and for side structures of the motor vehicle in order to reduce the severity of the accident consequence.

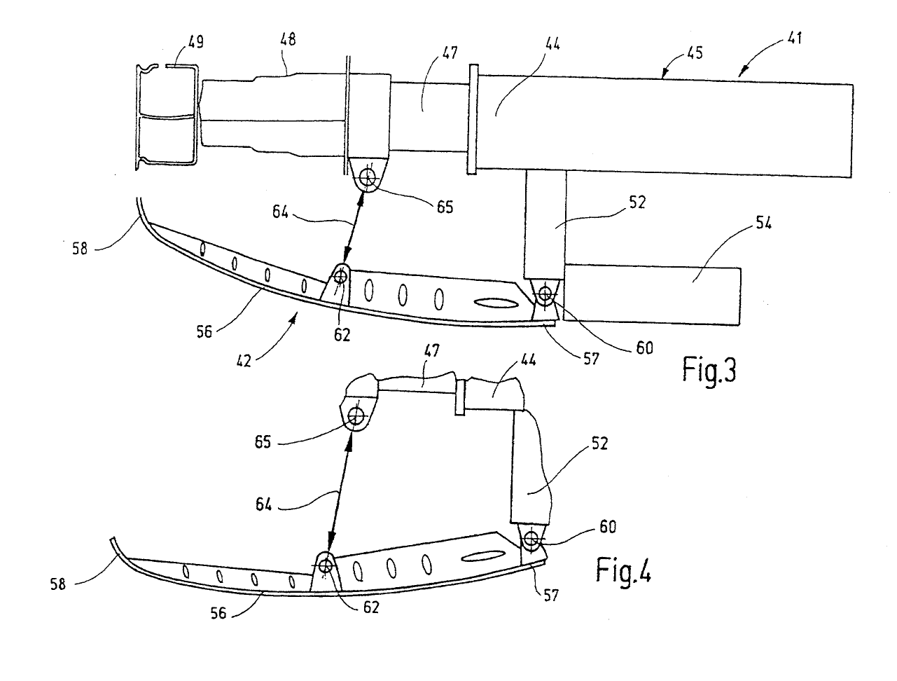

FIG. 3 illustrates the front region of a motor vehicle according to a further exemplary embodiment in section. An underprotection device 42 is fitted to a supporting structure 41. The supporting structure 41 comprises a front end 44 of a longitudinal member 45. A connecting member 47 extends forward from the front end 44 of the longitudinal member 45 and a crash box 48 is fitted to its front end. A crossmember 49 is fastened in turn to the front end of the crash box 48. The lower end of the connecting member 52 is supported on a further longitudinal member 54 in the longitudinal direction of the vehicle.

An impact plate 56 is fitted pivotably to the lower end of the connecting member 52 of the supporting structure 41. The impact plate 56 has a rear end 57 and a front end 58. The impact plate 56 is coupled at its rear end 57 to the lower end of the connecting member 52 at a coupling point 60. A further coupling point 62 is provided approximately in the center of the impact plate 56, via which coupling points an end of an actuator device 64 is coupled to the impact plate 56. The other end of the actuator device 64 is coupled to the connecting member 47 of the supporting structure 41 at a coupling point 65.

In FIG. 3, the impact plate 56 is in its retracted position. In FIG. 4, the impact plate 56 is in its extended position. The impact plate 56 has differing levels of rigidity in a front region and in a rear region. The front region is preferably provided with folding aids and, in the event of a crash, is activated together with a bending crossmember and crash boxes by the collision partner. The rear region of the impact plate 56 has significantly higher intrinsic rigidity in the longitudinal direction of the vehicle than the front region. In the event of a collision, the rear region forms an additional load path via which energy is introduced into the vehicle supporting structure 41 during a collision. The impact plate 56 can be of single-shell or two-shell design. The force level can be matched in a specific manner to the desired requirements via a bead geometry or by different wall thicknesses of the shells, for example by flexibly rolled raw materials. Better overlap with the accident counterpart can be achieved by specific embossings of the shells. In particular, sharp-edged end regions are avoided. In view of the repair costs incurred, the two regions of the impact plate 56 can preferably be removed separately.

Manual or automatic lowering of the impact plate 56 results in an inlet opening in the front end structure, which inlet opening can also be used in another manner. This gives rise, inter alia, to the following possibilities and advantages.

1. Access to a towing device: a towing device which comprises at least one towing lug can be arranged in the region of the inlet opening. The towing lug can be fastened directly to the body shell or on the impact plate inside which faces a vehicle interior. As an alternative, the towing device can additionally have a towing bush to which the towing lug can be fitted, for example screwed, the towing lug being removable from the bush. When the impact plate is arranged in the extended position, access to the towing lug/bush is opened up. Owing to the fact that the towing lug/bush is concealed when the impact plate is arranged in the retracted position, greater freedom of design is possible. In addition, unlike known towing devices which have a towing bush which is arranged in an opening in the front bumper arrangement and is intended for receiving a towing lug, a covering can be omitted for this opening, which provides a potential saving on costs.

2. Access to a hitching device which can be removed or folded down: a hitching device which is fastened to the body shell, to the bending member or to the crash box and which can be removed when not in use can be provided in the region of the inlet opening. According to a second variant embodiment, the hitching device is fitted fixedly to the body shell, to the bending member or to the crash box and can be unfolded into its functional position when the impact plate is arranged in the extended position. When the impact plate is arranged in the retracted position, the hitching device is preferably completely concealed. The arrangement of a hitching device in the front region of a vehicle makes it possible to simplify the parking and maneuvering of a trailer.

3. Access to fog lights: fog lights which can either be popped up or covered by the impact plate in the retracted position can be provided in the region of the inlet opening. Upon manual or automatic activation/deactivation of the fog lights, the impact plate can be lowered/set back in a controlled manner. The fog lights can be arranged/fastened either to a part fixed on the vehicle in the vicinity of the impact plate, which preferably also serves as an underbody covering, for example to a crossmember or a crash box, or on the impact plate. This arrangement of the fog lights is particularly advantageous in the case of off-road vehicles which have a high ground clearance, the arrangement making it possible for the headlights to be arranged closer to the carriageway. It is also advantageous that the fog lights, which are accommodated in a concealed manner, also permit a greater freedom of design and are better protected during off-road trips. In addition, the costs for the bumper can be reduced in comparison to known vehicles, in which the fog lights are arranged in the front bumper arrangement.

4. Use of aerodynamic effects during motorized actuation of the underprotection device.

5. Improvement of the engine cooling: the impact plate which can be swung out permits air to be additionally admitted from below via the inlet opening when the need arises, and therefore air is additionally conducted into the engine compartment, which may be arranged directly behind the opening, the air contributing to better cooling of the drive unit. In this way, the risk of the drive unit overheating can be significantly reduced. Also, in this case, the impact plate can be extended either manually or in a controlled manner, and it is possible for the following parameters to be coupled or used individually for the control:

engine temperature;

vehicle speed, for example speed limitation; and

carriageway conditions and/or ambient conditions, which, for example are not triggered during off-road trips.

As described above, the engine cooling is initiated by lowering of the impact plate, with the impact plate being manually or automatically reset into its retracted position after sufficient cooling, increased speed, a predefined period of time and/or further or different parameters.

6. Improvement of pedestrian protection.

7. Greater design possibilities.

8. Better introduction of energy into the body shell via the additional load path.

9. Additional energy consumption in certain load situations, as a result of which the “intrusion” can be reduced.

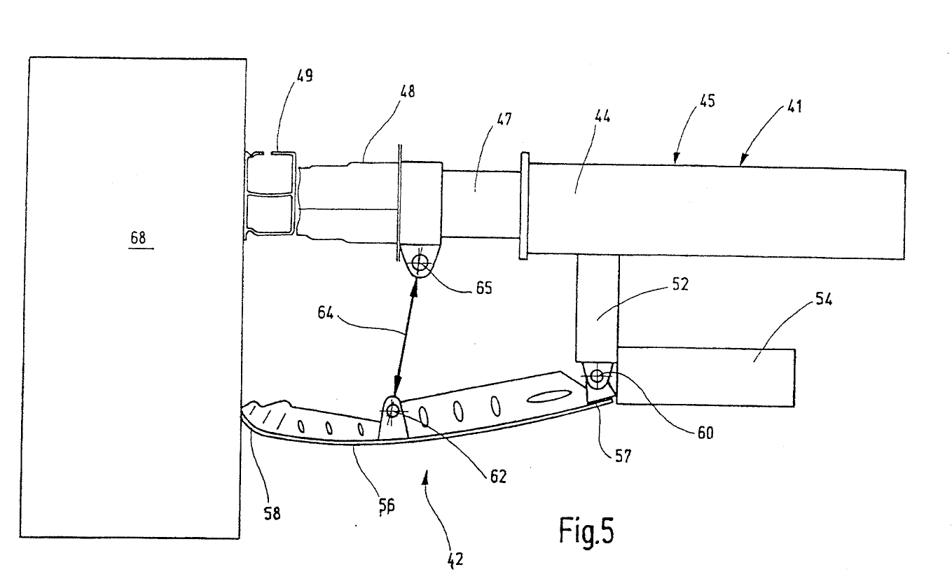

FIG. 5 illustrates the motor vehicle from FIG. 4 in the event of a collision with a barrier 68. It is seen in FIG. 5 that the crash box 48 has been compressed by virtually half of its length (in comparison to FIG. 3). In addition, the front region of intrinsic rigidity, which is arranged between the front end 58 and the coupling point 62, has been deformed, while the rear region of intrinsic rigidity of the impact plate 56 and the supporting structure 41 of the motor vehicle are not deformed.

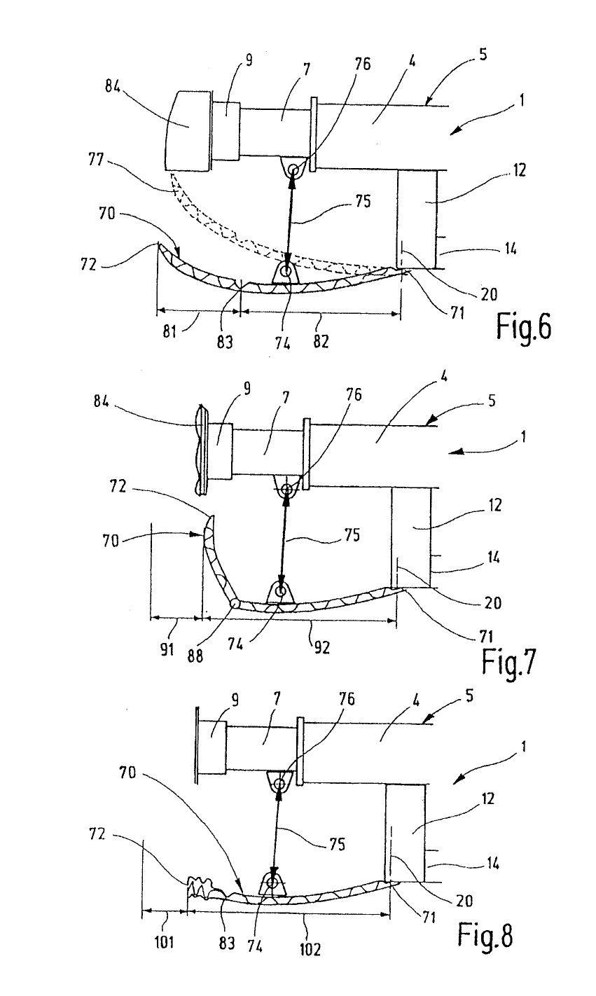

Underprotection devices similar to the ones in FIGS. 1 to 5 are illustrated in FIGS. 6 to 8. The same reference numbers are used to refer to the same parts. In order to avoid repetitions, reference is made to the preceding description of FIGS. 1 to 5. Only the differences between the individual exemplary embodiments are explained in more detail below.

In the case of the exemplary embodiment illustrated in FIG. 6, an impact plate 70 is coupled at a rear end 71 and a front end 72 to the lower end of the connecting member 12. The impact plate 70 has, approximately in its center, a coupling point 74, with the aid of which the impact plate 70 is coupled to one end of an actuator device 75. The other end of the actuator device 75 is coupled to the connecting member 7 of the vehicle supporting structure 1 via a coupling point 76. In FIG. 6, the impact plate 70 is illustrated in its extended position. The impact plate 70 is illustrated in its retracted position by means of dashed lines 77.

The impact plate 70 comprises a front section 81, which is also referred to as a deformation section, and a rear section 82, which is also referred to as a supporting section. The two sections 81, 82 are separated from each other in the manner of a hinge by a line of weakness 83. The supporting section 82 is deformed only in the event of forces which are greater than the forces at which the front section 81 would already be deformed/compressed. The coupling point 74 for the actuator device 75 is arranged in the region of the rear section 82, and therefore, when the front section 81 is interchanged, the actuator device 75 does not have to be removed/dismantled. Furthermore, during collisions with pedestrians, the front section 81 makes it possible for a leg to be supported on a second region below the bumper. This second region is formed by the front end 72 of the impact plate 70. The second lower region makes it possible to avoid a severe lateral bending of the knee joint of a pedestrian impacting on it laterally. In this case, the lower second region can have the same deformation rigidity as a deformation foam located under the bumper outer skin for the purpose of protecting the pedestrian. This ensures a parallel pushing up of the leg. In the case of the exemplary embodiment illustrated in FIG. 6, the deformation of the front section 81 is realized via tilting about the line of weakness 83.

In the case of the exemplary embodiment illustrated in FIG. 7, it is indicated that the deformation of the front rigidity section of the impact plate 70 can also take place by rotation about a hinge joint 88. The deformation path for a crash at low speed or during a collision with a pedestrian is indicated by 91. The deformation path which has a high level of rigidity is indicated by 92.

In FIG. 8, it is seen that the front section of the impact plate 70 can also be designed such that it is deformable in itself. The deformation path during accidents at low speed is referred to by 101. The deformation path 102 is associated with a high level of rigidity. The deformation path 102 is used only in cases of accidents at high speed.

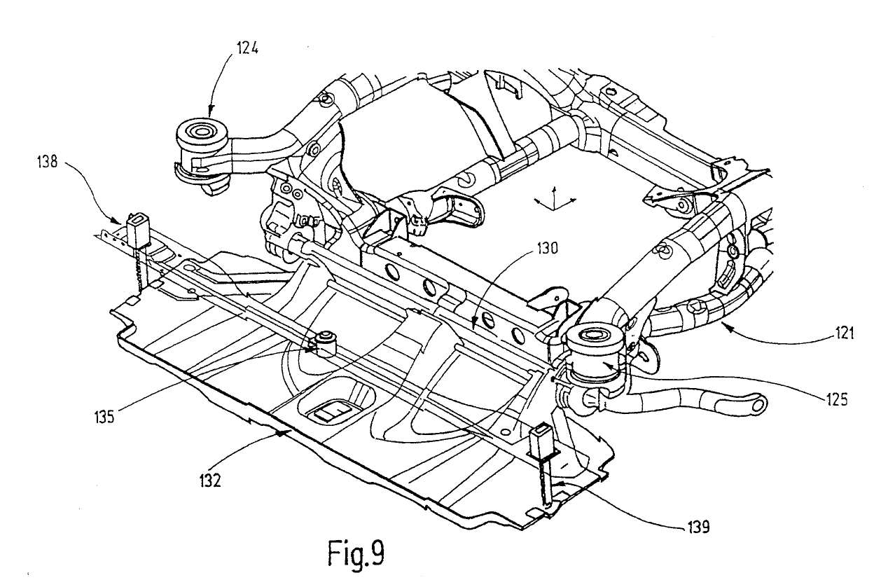

FIG. 9 perspectively illustrates an integral member 121 of a motor vehicle. Two engine bearings 124, 125 are fitted to the integral member 121. In addition, a stabilizer 130 is fitted to the integral member 121. According to a further aspect of the present invention, a two-shell impact plate 132 with a deformation structure is coupled to the stabilizer 130. If a triggering element 135 is triggered, then the impact plate 132 is pivoted about the stabilizer 130 with the aid of actuator devices 138, 139.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

We claim:

1. A motor vehicle with an underprotection device comprising an impact plate that is movable between retracted and extended positions and that is fitted to an underside of the motor vehicle, wherein the impact plate has regions of differing rigidity.

2. The motor vehicle as claimed in claim 1, wherein the impact plate is fitted pivotably to the underside of the motor vehicle.

3. The motor vehicle as claimed in claim 1, wherein the impact plate is coupled at least indirectly to a front axle member of the motor vehicle.

4. The motor vehicle as claimed in claim 1, wherein the impact plate extends into a front bumper region of the motor vehicle.

5. The motor vehicle as claimed in claim 4, wherein the impact plate is fitted, behind the front bumper region of the motor vehicle, to an actuator device.

6. The motor vehicle as claimed in claim 5, wherein the actuator device is fitted behind the front bumper region to supporting structure of the motor vehicle.

7. The motor vehicle as claimed in claim 5, wherein the actuator device comprises a plurality of actuator elements that form a supporting base for an impacting collision partner when the impact plate is in its extended position.

8. The motor vehicle as claimed in claim 1, wherein the impact plate is of deformable design in the longitudinal direction of the motor vehicle.

9. The motor vehicle as claimed in claim 1, wherein the impact plate has high intrinsic rigidity in the longitudinal direction of the motor vehicle.

10. The motor vehicle as claimed in claim 1, wherein the impact plate comprises an outer region of rigidity and an inner region of rigidity, and wherein the inner region of rigidity has significantly higher intrinsic rigidity in the longitudinal direction of the motor vehicle than the outer region of rigidity.

11. The motor vehicle as claimed in claim 10, wherein the outer region of rigidity is a front region and the inner region of rigidity is a rear region.

12. The motor vehicle as claimed in claim 11, wherein folding aids are provided in the outer region of rigidity or the front region.

13. The motor vehicle as claimed in claim 1, wherein the impact plate comprises an outer deformation section fitted to an inner supporting section that has higher rigidity than the deformation section.

14. The motor vehicle as claimed in claim 13, wherein the outer deformation section is a front deformation section and the inner supporting section is a rear supporting section.

15. The motor vehicle as claimed in claim 14, wherein the outer deformation section or the front deformation section is of interchangeable design.

16. The motor vehicle as claimed in claim 13, wherein the outer deformation section is fitted pivotably to the inner supporting section.

17. The motor vehicle as claimed in claim 1, wherein the impact plate is movable from the retracted position into the extended position by motor or manually.

18. The motor vehicle as claimed in claim 1, wherein the impact plate is arranged in its extended position during normal operation of the motor vehicle and is moved into the retracted position only when the need arises.

19. The motor vehicle as claimed in claim 1, wherein the impact plate is arranged in its retracted position during normal operation of the motor vehicle and is moved into the extended position only when the need arises.

20. The motor vehicle as claimed in claim 2, wherein the impact plate is fitted to a stabilizer.
